(19) United States
(12) Patent Application Publication
(10) Pub. No.: US 2010/0264672 A1
(43) Pub. Date: Oct. 21, 2010

(54) Double draw bar spring mechanism

(76) Inventor: Philip C. Ellis, Newtown Square, PA (US)

Correspondence Address: Royal W. Craig, Esq.;Ober/Kaler, 120 East Baltimore Street, Baltimore, MD, 21202-1643, US

(21) Appl. No.: 12/386,460

(22) Filed: Apr. 17, 2009

(51) Int. Cl. E05C 19/06

(52) U.S. Cl. 292/87; 292/80

(57) ABSTRACT

A double slide arm spring mechanism for biasing a primary mechanism to home position after operation and retaining the primary mechanism in the home position pending further operation. The double slide arm spring mechanism includes a pair of slideably interlocking arms each having a longitudinal frame member and a spring engaging flange at each end. The frame members are a disposed to engage one another while permitting relative sliding of the arms. The slide arms are interlocked such that one flange of each arm is situated between the two flanges of the other arm. Two compression springs are retained between the flanges of the arms such that sliding of either arm toward the other necessarily compresses both springs. Potential energy stored in the springs returns the slide to its neutral position when the operator is released thereby also returning the operator to its neutral position. The slide arms produce twice as much force to return operator to it neutral position as would be possible using springs of the same length operated independently.

### BRIEF DESCRIPTION OF THE DRAWINGS

The objects, features, and advantages of the present invention will become apparent from the following detailed description of the preferred embodiments and certain modifications thereof when taken together with the accompanying drawings in which like numbers represent like items throughout and in which:

FIG. 1 is a perspective view of the fully assembled power pack in conjunction with a door lever, spindle and tubular latch.

FIG. 2 is a perspective view of the power pack assembly in conjunction with a spindle.

FIG. 3 is perspective view of the power pack in conjunction with a spindle and with the cover plate removed and the springs omitted.

FIG. 4 is an isolated perspective view of the slide arms with the springs and other elements omitted.

FIG. 5 is a front view of the power pack with the cover plate removed and the springs inserted.

FIG. 6 is an isolated perspective view of the slide arms with the springs and spindle hub included.

FIG. 7 is a front view of the power pack with the cover plate removed in a displaced condition.

### DETAILED DESCRIPTION OF THE PREFERRED EMBODIMENT

For the purposes of promoting an understanding of the principles of the invention, reference will now be made to the exemplary embodiment illustrated in the drawings and described below. The embodiment disclosed is not intended to be exhaustive or limit the invention to the precise form disclosed in the following detailed description. Rather, the embodiment is chosen and described so that others skilled in the art may utilize its teachings. It will be understood that no limitation of the scope of the invention is thereby intended. The invention includes any alterations and modifications in the illustrated device, the methods of operation, and further applications of the principles of the invention which would normally occur to one skilled in the art to which the invention relates.

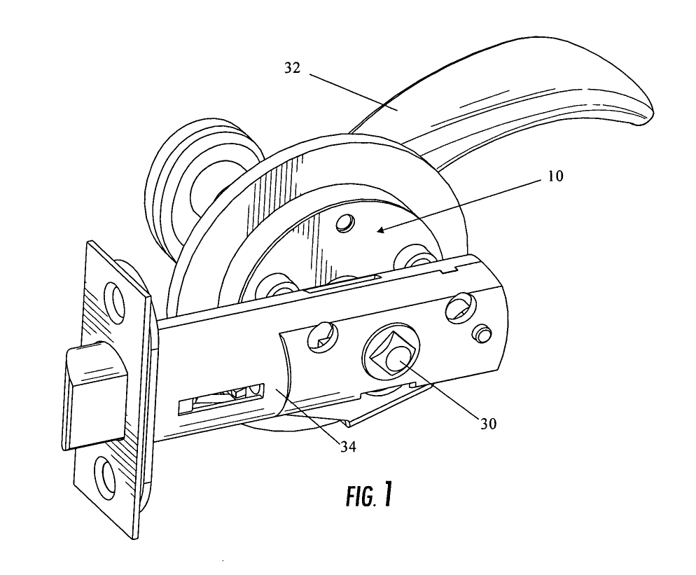

The invention is a power pack assembly for biasing a primary door opening mechanism to a neutral or home position after being manually displaced from the home position, and for retaining the primary mechanism in that home position despite ambient forces (such as the force of gravity acting on the door lever), until such time as additional manual force is applied to again operate it. Displacement of the primary mechanism may be rotational or angular displacement about an axis, or linear displacement. As depicted in FIG. 1, the invention is described herein in the context of a door handle set, with a latch being the primary mechanism, such that angular rotation of a spindle 30 in response to operation of a door lever 32 to retract the bolt 31 of tubular latch 34 is contemplated. The power pack assembly 10 according to the present invention is low-profile, may be countersunk into the door, and serves to return the door lever 32 (or a door knob) to a generally horizontal home position after the latch has been operated and assists in returning the bolt 31 to the extended position.

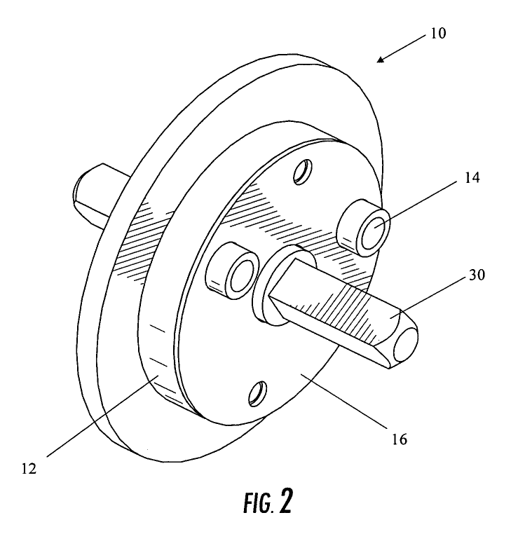

FIG. 2 depicts the power pack assembly 10 isolated from the door lever 32 and latch 34 but with spindle 30 in place. A housing 12 is provided. Housing 12 is preferably circular in form having a diameter of less than 2⅛ inch so as to be partially recessed within the standard size holes provided within commercial doors for installation of the handle set. Housing 12 may be integrally formed with a decorative rose plate 33 for flush seating on the surface of the door around the handle set knob or lever 32. A plurality of holes 14 may be provided through the housing 12 for securing the housing directly to the door, or as illustrated through-bolting through the tubular latch 34 to a cooperative rose plate on the opposite side of the door. The housing 12 includes a removable cover plate 16 for easy assembly and servicing of the power pack 10.

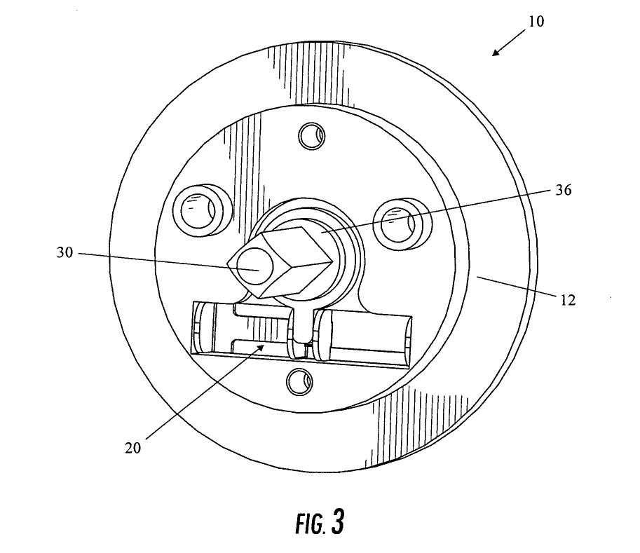

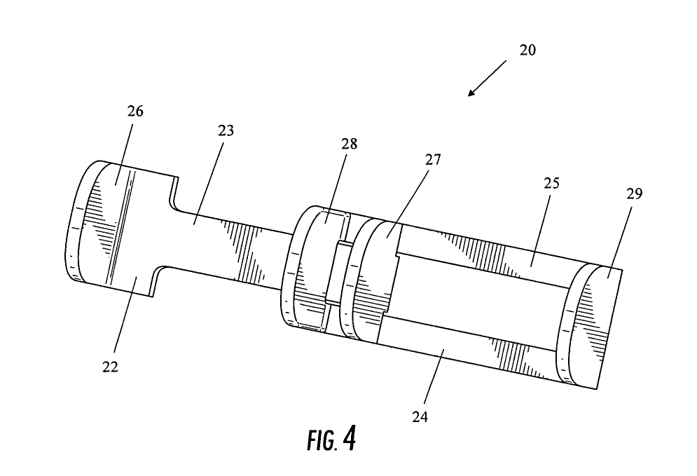

With the cover plate 16 removed, as depicted in FIG. 3, slide arms 20 are visible, slideably retained within the housing 12. The compression springs (described below) have been omitted for clarity in this view. With further reference to FIG. 4, the slide arms 20 include a first arm 22 and a second arm 24 slideably interlocked together. Arms 22, 24 each have a primary longitudinal frame member 23, 25, respectively. Frame members 23, 25 are a disposed to engage one another while permitting relative sliding of the arms 22, 24 along their longitudinal axes. As depicted, one frame member 23 is provided in the form of a narrow central rail running between orthogonal flanges 26, 27 at either end. The other frame member 25 is depicted as a spaced pair of upper and lower rails running between orthogonal flanges 28, 29 at either end. The upper and lower rails of frame member 25 are spaced to receive the central rail of frame member 23. Flange 27 is truncated where it joins frame member 23 to provide clearance to allow the upper and lower rails of frame member 25 to pass.

Flanges 26, 27, 28, 29 anchor compression springs (not shown in this view), and for this purpose may be generally orthogonal tabs projecting from their respective frame members. However, the flanges 26, 27, 28, 29 may take other forms including protrusions, hooks, pins or any other means for retaining a spring including tack welds of the spring ends directly to the respective frame members. As stated, first and second arms 22, 24 are interlocked such that flange 28 is situated between flanges 26 and 27. Similarly, flange 27 is situated between flanges 28 and 29, as best seen in FIG. 4. It should be observed that first and second arms 22, 24 need not be directly interlocked with one another as depicted herein but rather may be engaged by being separately slideably retained within, for example, a housing such that that their flanges 26, 27, 28, 29 are interposed as described above. First and second arms 22, 24 are, in such an embodiment, mechanically linked by the compression springs alone, as described below.

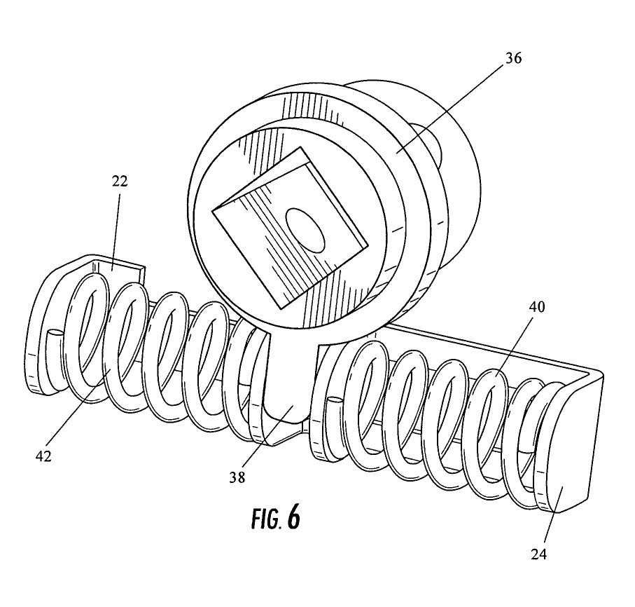

FIG. 6 illustrates two compression springs 42, 40 mounted in the slide arms 20 between the flanges 26, 27, 28, 29. A first compression spring 42 is thus retained between flange 26 and flange 28, while a second compression spring 40 is retained between flange 27 and flange 29, the first and second arms 22, 24 being mechanically linked and biased apart by compression springs 40, 42.

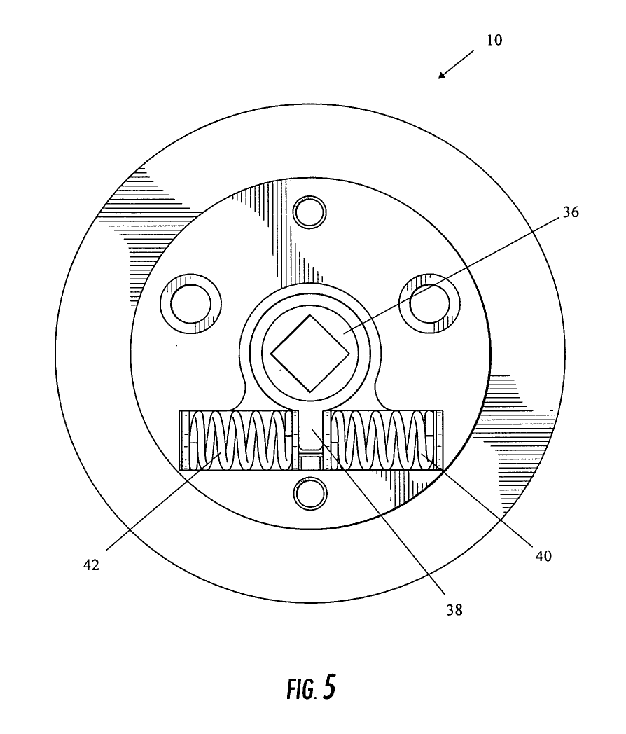

With reference to FIGS. 3 and 5, a spindle hub 36 is rotatably mounted within housing 12. Spindle hub 36 receives the keyed spindle 30 mechanically linking the power pack 10 with door lever 32. The spindle 30 is keyed to the spindle hub 36, generally having a non-round cross-section (for example, square as shown), and spindle hub 36 is cooperatively shaped to receive and rotate with the spindle 30. Spindle hub 36 is further provided with a cam 38 extending radially from the spindle 30 to engage the slide arms 20. Specifically, as best seen in FIG. 6, cam 38 extends between the two center flanges 27, 28. This way, as door lever 32 is rotated the spindle hub 36 is rotated in the same direction via the spindle 30 thereby rotating and laterally displacing the cam 38. Cam 38 is sized to provide the necessary lateral displacement of the cam to engage the slide arms 20. The greater the maximum length of the cam 38 from the rotational center of the hub the greater the lateral displacement cam 36 and slide arms 20 and thus the greater the compression of the springs 40, 42, as further described below.

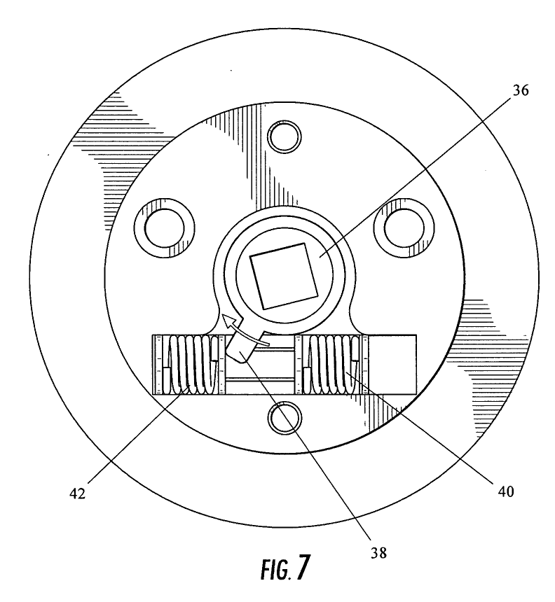

Counterclockwise rotation of cam 38 engages the first slide arm 22 at flange 27, and clockwise rotation of cam 38 engages the second slide arm 24 at flange 28. Thus, as depicted in FIG. 7, clockwise rotation of the spindle hub 36 forces flange 28 to slide into and compress first spring 42 between itself and flange 26, flange 26 being held in place by the housing 12. At the same time, sliding of flange 28 draws flange 29 in the same directing via frame member 25, thereby simultaneously compressing second spring 40 between flange 29 and flange 27, flange 27 being held in place via frame member 23 and flange 26 contacting the housing 12. The compression of first and second springs 42, 40 creates potential energy, and springs 42, 40 return-bias second arm 24 to the home position when the door lever 32 is released thereby forcing the lever 32, via the hub 36 and spindle 30, back to its neutral horizontal position and retaining it in that position indefinitely.

Rotation of the spindle hub 36 in the opposite direction produces a like result, with cam 38 forcing flange 27 to slide into and compress second spring 40 between itself and flange 29, which is held in place by the housing 12. At the same time, sliding of flange 27 draws flange 26 in the same directing via frame member 23, thereby simultaneously compressing first spring 42 between flange 26 and flange 28, flange 28 being held in place via frame member 25 and flange 29 contacting the housing. Potential energy again stored in first and second springs 42, 40 likewise returns and maintains first arm 22 and thus door lever 32 in the home position when the door lever 32 is released.

One skilled in the art will now see that the foregoing configuration provides compression of both compression springs 40, 42 regardless of which direction the spindle 30 is rotated thereby providing maximum reverse bias return the spindle 30 and any knob or lever connected thereto to the rest position. This produces twice as much force as would be possible using independent springs of the same length, and entirely eliminates the need for more expensive and less reliable expansion springs or torsion springs yet applies the entire righting force of both springs in compression only leading to more both reliable operation and less expensive manufacture. The forgoing design further simplifies the mechanisms of the prior art, reducing the total number of parts thereby providing smoother operation and reduced wear cost.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims and may be used with a variety of materials and components. This application is therefore intended to cover any variations, uses, or adaptations of the invention using its general principles. Further, this application is intended to cover such departures from the present disclosure as come within known or customary practice in the art to which this invention pertains.

I claim:

1. A biasing apparatus for returning a rotatably-mounted member to a neutral position comprising:
a pair of slideably engaged slide arms, said slide arms further comprising,
a first arm having a first end and second end, and
a second arm having a first end and second end,
said first arm and second arm being slidably engaged such that said first end of said second arm is slideably positioned between the first and second ends of said first arm and the second end of said first arm is slideably engaged between said first and second ends of said second arm;
a first spring retained between said first end of said first arm and said first end of said second arm;
a second spring retained between said second end of said first arm and said second end of said second arm; and
an operator protruding from said rotatably-mounted member between said second end of said first arm and said first end of said second arm for thereby engaging said first arm and said second arm;
whereby displacement of said operator in a first direction causes said second arm to slide thereby simultaneously compressing said first and second springs and displacement of said operator in a second direction causes said first arm to slide thereby simultaneously compressing said first and second springs.

2. The biasing apparatus of claim 1 wherein said operator comprises a cam protruding orthogonally from said rotatable member.

3. The biasing apparatus of claim 2 further comprising a spring engaging flange protruding from each of said first and second ends of said first and second arms.

4. The biasing apparatus of claim 3 wherein said cam is disposed between the spring engaging flange at the second end of said first arm and said spring engaging flange at the second end of said second arm for alternate engagement thereof.

5. The biasing apparatus of claim 1 further comprising a housing, said slide arms being slideably retained in said housing.

6. The biasing apparatus of claim 1 wherein said operator comprises a cam extending radially from a spindle hub for rotation therewith.

7. The biasing apparatus of claim 6 wherein said rotatable member comprises one of a door knob or lever attached to a spindle, said spindle being engaged in said spindle hub.

8. The biasing apparatus of claim 1 wherein said first spring and said second spring are compression springs.

9. The biasing apparatus of claim 4 wherein said spring engaging flanges form an approximately 90 degree angle with said slide arms.

10. A power pack assembly for returning a door operator to a neutral position comprising:
a housing;
a pair of engaged slide arms slideably retained in said housing, said slide arms further comprising,
a first slide arm having a first end and second end, and
a second slide arm having a first end and second end,
said slide arms each having a spring engaging flange at each end, said slide arms further engaged such that said first end of said second slide arm is slideably position between the first and second ends of said first slide arm and the second end of said first slide arm is slideably engaged between said first and second ends of said second slide arm;
a first spring retained between the spring engaging flange of said first end of said first slide arm and the spring engaging flange of said first end of said second slide arm;
a second spring retained between the second spring engaging flange of said first slide arm and the second spring engaging flange of said second slide arm;
a hub rotatably mounted in said housing for receiving a spindle of said door operator, said hub further comprising a cam projecting radially there from, said cam disposed between said second spring engaging flange of said first slide arm and said first spring engaging flange of said second slide arm whereby rotation of said operator in a first direction causes said second slide arm to slide thereby simultaneously compressing said first and second springs and rotation of said operator in a second direction causes said first slide arm to slide thereby simultaneously compressing said first and second springs.

11. The power pack assembly of claim 10 wherein said door operator is a knob or lever.

12. The power pack assembly of claim 10 wherein said housing is circular in cross section.

13. The power pack assembly of claim 12 wherein said housing is disposed for mounting to the face of a door.

14. The power pack assembly of claim 13 wherein said housing is directly mounted to the door by screws.

15. The power pack assembly of claim 13 wherein said housing is mounted by through-bolting to a cooperative plate on an opposite side of said door.

16. The power pack assembly of claim 12 wherein said housing is less than 2⅛ inch in diameter.

17. A power pack assembly for returning a door operator to a neutral position comprising:
a housing,
a pair of engaged slide arms slideably retained in said housing,
a pair of compression springs retained within said slide arms, each compression spring being attached at one end to one of said slide arms and being attached at another end to another of said slide arms; and
a hub rotatably mounted in said housing for receiving a spindle of said door operator, said hub further comprising a cam projecting radially there from to a distal end engaged to said pair of slide arms.

18. A mechanism for returning a door knob or lever to a neutral position after turning and release, comprising a double slide arm mechanism including a first slide arm and a second slide arm, said first and second slide arms being slidably engaged together for relative extension and retraction, a first compression spring biasing one end of said first slide arm against one end of said second slide arm, a second compression spring biasing another end of said first slide arm against another end of said second slide arm, and a hub extending a cam to engage said first slide arm when said hub is rotated in one direction and to engage said second slide arm when rotated in another direction.

19. A method of biasing a rotatable member to a home position comprising the steps of:
providing a pair of slide arms, said slide arms comprising a first and second slide arm each having a first end and a second end;
slideably mounting said slide arms to a base such that said first end of said second slide arms is interposed between said first and second ends of said first slide arm and said second end of said first slide arm is interposed between said first and second ends of said second slide arm, each slide arm being constrained within a range of sliding movement back and forth to/from an initial position;
connecting a first compression spring to said first end of said first slide arm and said first end of said second slide arm;
connecting a second compression spring to said second end of said first slide arm and said second end of said second slide arm;
providing an operator for alternately engaging one of said slide arms when said rotatable member is rotated clockwise from a home position, and engaging the other of said slide arms when said rotatable member is rotated counter-clockwise from said home position, in both instances simultaneously compressing said first and second compression springs and generating a return bias for returning said rotatable member to said home position.

20. The method of biasing a mechanism to a home position of claim 19 wherein said rotatable member comprises one of a door knob or door lever.

21. The method of biasing a door knob or lever to a home position of claim 19 wherein said operator is a spindle hub, said hub further including a cam for contacting said slide arms.

22. A biasing apparatus for returning a rotatably-mounted member to a neutral position comprising:
a first spring having a longitudinal axis;
a second spring having a longitudinal axis, the second spring being disposed coaxially with the first spring;
an operator coupled to the rotatably-mounted member and disposed between the first spring and the second spring, the first spring and second spring being axially compressed in response to rotation of the rotatably-mounted member.

23. The biasing apparatus of claim 22 further comprising
a first slide arm slideably engaged with a second slide arm, said first and second slide arms further engaged with said operator, the first slide arm sliding in response to rotation of the rotatably-mounted member in a first direction so as to axially compress both the first spring and second spring, the second slide arm sliding in response to rotation of the rotatably-mounted member in a second direction so as to axially compress both the first spring and second spring.
